(19) United States
(12) Patent Application Publication
(10) Pub. No.: US 2014/0238307 A1
(43) Pub. Date: Aug. 28, 2014

(54) METHOD OF PROTECTING FISH

(71) Applicants: Uwe Weibel, Kandel (DE); Andreas Ness, Heidelberg (DE)

(72) Inventors: Uwe Weibel, Kandel (DE); Andreas Ness, Heidelberg (DE)

(73) Assignee: IUS WEIBEL & NESS GMBH, Kandel (DE)

(21) Appl. No.: 14/354,554

(22) PCT Filed: Oct. 25, 2012
(86) PCT No.: PCT/DE2012/001031

§ 371 Date: Apr. 25, 2014

(30) Foreign Application Priority Data
Oct. 25, 2011 (DE) 10 2011 116 911.7

(51) Int. Cl. A01K 79/02; H05C 1/04

(52) U.S. Cl. CPC A01K 79/02; H05C 1/04
USPC 119/220

(57) ABSTRACT

Embodiments of the present invention relate generally to methods of moving or herding fish, such that the fish are protected from being removed from their natural aquatic environments when water containing these fish is withdrawn and used for industrial purposes. Additionally, the invention relates to a method for shooing or driving fish out of a specific region using at least one screen, including applying current and/or voltage pulses to the screen in order to facilitate the moving of the fish.

### CROSS REFERENCE TO RELATED APPLICATION

This U.S. Non-provisional application is being filed as a 371 and claims priority under 35 U.S.C. 121 to PCT Application No. PCT/DE2012/001031 filed Oct. 25, 2012 which claims the benefit of DE Application No. 10 2011 116 911.7 filed Oct. 25, 2011, which are incorporated herein in their entirety for all purposes.

### FIELD

Embodiments of the present invention relate generally to methods of shooing fish out of a specific area, such that the fish are protected from being removed from their natural aquatic environments when water containing these fish is withdrawn and/or used for industrial purposes.

### BACKGROUND

There are numerous technical plants or installations which withdraw large amounts of water from waters, for example, for realizing the cooling of power plants.

A large number of different fish species live in sufficiently clean waters. It is extremely undesired that fish are removed from the waters together with the water to be used for technical purposes, not only for reasons of ethical animal protection or reasons of nature and water protection per se, but also because their removal has negative effects on fishing and on the technical installations downstream.

Therefore, it is desired to shoo the fish away from those regions in which they might be sucked in and taken out together with the water to be withdrawn. The present invention deals with this problem.

It is known to expose fish to stroboscope light in order to drive away the fish. It is also known to use electrical fields for driving away fish. Reference is made to the publication ATV-DVWK (2004 “Fischschutz- and Fischabstiegsanlagen-Bemessung, Gestaltung, Funktionskontrolle” ATV-DVWK work group WW-8.1, Hennef, ISBN 3-934063-91-5).

### SUMMARY

The present invention relates to a method for shooing fish out of a specific region, characterized in that in the region at least one screen is provided in the water and current and/or voltage pulses are applied to the at least one screen.

The method for shooing fish can also be characterized in that fish are shooed out of a water suction and/or inlet area of a technical installation, in particular a power plant.

The method for shooing fish can also be characterized in that it is used in waters in which a plurality of different species of fish to be shooed are present, in particular more than one species of eels, salmon, or trout.

The method for shooing fish can also be characterized in that it is used in flowing waters.

The method for shooing fish can also be characterized in that the screen bars are switched alternatingly, or optionally in a group wise and/or temporarily alternating manner.

The method for shooing fish can also be characterized in that the pulse repetition frequency is selected to be smaller than 20 Hz, in particular smaller than 10 Hz, preferably between 3 Hz and 5 Hz.

The method for shooing fish can also be characterized in that the pulses have a steep rising edge, preferably with a rise to the maximum in a time period smaller than 2.5 ms, particularly preferably about 1 ms or less.

The method for shooing fish can also be characterized in that the fish are shooed in the direction of free waters and/or in the direction of a bypass or a return path.

The method for shooing fish can also be characterized in that the pulse repetition frequency and/or the pulse strength can be varied depending on the season and/or the time of day and/or the temperature.

The method for shooing fish can also be characterized in that the at least one screen to which a current and/or power pulse is applied is used together with at least one further retaining barrier, in particular a barrier effective for another fish species and/or a large shooing barrier.

The method for shooing fish can also be characterized in that sound, pressurized air and/or light installations are used as further barrier, in particular with pulses being applied.

The present invention also provides a screen or screens for shooing fish, characterized in that a plurality of metallically conducting screen bars and/or groups of bars which are insulated against each other or from one another.

The present invention also provides a screen installation for shooing fish, comprising a screen and a power and/or current pulse source for applying different current and/or voltage pulses to the screen bars which are insulated against each other or from one another.

The present invention also provide a screen installation characterized in that the screen bars are realized by elongate metal sheets.

### BRIEF DESCRIPTION OF THE DRAWINGS

FIG. 1 is an exemplary image of certain methods of shooing fish, according to one embodiment of the present invention.

### DESCRIPTION

The subject matter of the present invention relates to the moving of fish out of a particular area, such that the fish are protected from being removed from their natural aquatic environments when water containing these fish is withdrawn and used for industrial purposes. Additionally, the invention relates to a method for shooing or driving fish out of a specific region using at least one screen, including applying current and/or voltage pulses to the screen in order to facilitate the moving of the fish.

It is a problem of the presently used methods and arrangements for shooing fish that, as a rule, they only have a quite insufficient efficiency. In other words: Only a very small part of the fish can be prevented from being supplied to the technical installations together with the water. Again, in other words: The number and amount of fish taken out together with the water are still clearly too high although known shooing methods and shooing installations are used.

It is desirable to improve the shooing effect, i.e. to ensure more efficiently that no longer so many fish are unintentionally taken out of the waters in regions such as suction points. It is also desirable to provide an improved method and/or an improved arrangement for shooing fish out of specific regions.

It is the problem of the present invention to provide new subject-matter for industrial applications.

The solution to this problem is claimed in independent form. Preferred embodiments can be found in the dependent claims.

Thus, the present invention deals with a method for shooing or driving fish out of a specific region. It is intended that in said region at least one screen is provided in the water and that current and/or voltage pulses are applied to this at least one screen.

This method can be implemented in an advantageous manner because in regions in which large amounts of water are withdrawn, screen installations are typically already present, so that it is not necessary to build new structures for implementing the method but it is possible to modify existing plants or installations. In accordance with a simple alternative of the method it is thus possible to use the screen structures which are already present for holding off floating objects such as branches or persons, for example careless swimmers. It does not count in this connection that the actual screens must possibly be replaced by screens to which a current and/or voltage pulse can be applied, that protective screens must be provided upstream thereof in order to protect careless swimmers and the like from getting in contact with the screens to which a current and/or voltage pulse can be applied in accordance with the invention, etc. Therefore, the invention can be implemented easily.

In particular, it is possible to use screens for the invention in which the distance between the screen bars is the same as in that used so far for holding off branches, floating objects and the like. In accordance with the present invention, a screen bar is also an arrangement in which the screen bars are not round or quadrangular but elongate as known in louvers. In accordance with the invention, louvers are suitable as screens and are comprised by the term “screen”. These louvers can be formed by bars or the like being arranged transversely with respect to the flow direction, which improves the protection against floating-through already without applying voltage and/or current pulses to the screen in accordance with the invention. It is pointed out that it is easily possible to separate the installation per se in a galvanic manner from the grid, for example by using suitable separating transformers. It is possible to use a pre-screen protecting, e.g., a person in the water. Said pre-screen is preferably arranged and dimensioned such that contact by hands, arms or legs of persons and children passing through between the screen bars can be reliably prevented.

It appears that the use of a screen to which voltage and/or current pulses are applied, in particular in an alternating manner, for shooing the fish is much more effective than the use of a screen with assigned and far away counter-electrodes which should generate a field stretching over a wide area. Thus, the invention leads to a considerably improved shooing effect.

The method can be used in particular in water suction areas and/or water inlet areas of technical installations as used in power plants for sucking cooling water. It goes without saying that this method also makes sense in other respects such as water suction in chemical plants.

The method can be used particularly advantageously if it is necessary to shoo different fish species. Many different fish species often live in healthy waters. For example, quite large numbers of eels, salmons and trouts live in healthy large flowing waters. The different fish species show different reactions to different shooing patterns, as will be explained below. However, the method is still efficient if there is no specific adaptation to the fish species to be shooed predominantly, but if a power and/or voltage pulse is selected which, on average, is suitable for many species.

Although it is easily possible to use the method in open waters, if necessary also in the sea, i.e. in salty water having a relatively good conductivity, or in lakes, it is particularly preferred to use it in flowing waters in which fish of many species are migrating to a particularly large extent.

It is possible and preferred to switch the screen bars alternatingly, i.e. to change between plus pole and minus pole from bar to bar or from group of bars to group of bars. It is not mandatory to assign always only the same polarity to one and the same screen bar. Rather, for example during a specific application phase, also a change in the polarity of the groups can be made. This can prevent voltage-caused corrosion.

The question whether the polarity is alternatingly changed from bar to bar (or—which is considered to be identical in the present case because only the potential differences between the bars are important—whether only individual bars are not switched) or whether groups are formed firstly depends on how closely the bars are arranged next to one another. Typical distances are between 5 and 15 cm: Too small bar distances have the drawback known per se that the screen installation becomes polluted too quickly. It is pointed out in this regard that cleaning arrangements which are known per se can be assigned to a screen installation according to the invention. Bars which are spaced too much from each other do not sufficiently keep off large-sized objects. In view of the dependency of the shooing effect on the grouping, it should be taken into account that in case the polarity alternates closely, for example from bar to bar or from a group of two bars to the next two bars, the electrical field does not extend so far once a pulse is applied to the screen installation than it does in case large groups such as, e.g., a group of 10 screen bars or 20 screen bars next to each other have the same polarity and only then the polarity is changed. However, the field extension influences the shooing effect on specific fish species. In tests it has been found out that the connection of the screen bars in groups even plays a more important role than the selection of voltage and frequency.

The grouping of the screen bars thus also determines when the escape reaction starts. For example, if groups of ten bars were switched together, salmons already showed an escape reaction at a distance of about 50 to 60 cm. In individual cases, even escape distances of up to 10 m were monitored.

It might be desirable to vary the field extension for the shooing of different fish species or fish having different sizes. It should be taken into account that in a field having a given field strength, very long fish such as eels are exposed to a larger potential difference between tail and head than smaller fish. Thus, they possibly already react at a larger distance to the shooing pulses at the screen installation. At the same time, however, it should be taken into account that in a fish being close to the screen installation, the pulses cause muscle contractions and thus affect the ability of the fish to swim. In eels, however, only parts of the muscles which are necessary for the movement and thus the escape of the fish are affected, so that in case of quickly alternating polarities from bar to bar and the resulting field, which has only a small extension transversely with respect to the screen installation, the fish to be shooed away can escape even better. The grouping can thus depend, i.a., on the size of the fish. Therefore, the grouping should preferably be adapted to the desired or required escape distance and/or, for example, the fish species.

The escape distance was moreover also dependent on the approaching direction. The approaching direction at the same time determines the current densities which are necessary for causing the escape reactions and which must, e.g., be between 4 to 5 A/m² in case of a parallel approach and only about 1 A/m² in case of a perpendicular screen approach. Current densities between 0.1 to 5 A/m², preferably between 1 and 2 A/m², turned out to be advantageous current densities. It is pointed out that these preferred current densities can vary with the conductivity of the water, the distance of the screen bars as well as in view of the physiology of the fish, also with the fish species, the temperature of the water, the season etc. as well as the pulse repetition frequency.

In a preferred alternative of the method, the pulse repetition frequency is lower than 20 Hz, in particular lower than 10 Hz and preferably between 3 to 5 Hz. If the pulse repetition frequency is too low, the fish possibly swim though the screen in order to escape the pulses which are unpleasant to them. However, if the pulse repetition frequency is too high, the muscles of the fish to be shooed contract too often and the fish does not have any chance at all to escape the field being unpleasant to it. The mentioned pulse frequencies take this into account. However, it should be taken into consideration that there are frequency ranges in which paralytic symptoms might occur in specific fish species. For example, in tests with salmons, first paralytic symptoms were monitored at a frequency of 8 Hz. Paralytic symptoms make the fish unable to swim against the flow direction of the sucked water.

The preferred voltages are typically between 10 and 200 Volts. It appears that already low voltages lead to good shooing effects, which is advantageous in connection with structural and safety-related aspects.

It also proved to be advantageous if the pulses have a steep rising edge. Said rising edge should be so steep that the current and/or voltage maximum is typically reached within 1 ms. Shooing tests carried out with different fish species indicate that the nerve stimulation caused in the fish in case of steep edges is advantageous for a given current and/or voltage maximum.

The method is preferably used such that a bypass is provided for the fish in the direction of which they can be shooed. In particular, it is possible to reduce the shooing effect in the vicinity of the bypass or to arrange the bypass such that two separate shooing screens or the like shoo in the direction of the bypass.

In a particularly preferred alternative, the pulse repetition frequency, the pulse strength, the grouping of screen bars and optionally the interaction with other retaining barriers such as other screens and the like, also switched in accordance with the invention, can be varied depending on the season, the time of day and/or the temperature and optionally depending on a fish population currently expected and/or determined, e.g., by fishing. The variation depending on the temperature, time of day and season can make sense because at different times and temperatures, different fish or fish species are more active and different fish species possibly need different shooing parameters.

It makes sense and is possible to provide a controller which, if necessary, automatically follows a predetermined pattern which varies one, more or all of pulse strength, pulse density, interconnection, etc. depending on one or more of said influencing parameters. This controllers can be computer-assisted. The corresponding ideal shooing patterns with respect to pulse repetition frequency, pulse strength, interaction with other retaining barriers such as light, air curtains in the water, sound irradiation etc. can be determined in particular on the basis of tests. It should be taken into account in this connection that in specific countries shooing tests are animal experiments and have to be notified.

It is particularly preferred if, in addition to the at least one screen to which current and/or voltage pulses are applied, as described above, further retaining barriers for shooing are used together. For example, the attempt to use stroboscopes is known but not sufficient per se. Also air curtains, which are generated by blowing air out of a tube close to the ground, can cause a barrier effect, wherein this can also be done in a pulsed fashion, if required, and also underwater loudspeakers and the like can be used. It is also possible to connect several screens according to the invention one after the other. In such a case, a field can be generated in particular also between the screens, possibly also a field which is pulsed in a manner different from that of the field of the first screen and/or different field strengths can be selected for the various screen rows.

Protection is not only claimed for the realization of the method itself, but also for a screen or screen installation adapted to perform the method, in particular with a pulse source causing the current and/or voltage pulse application and varying, if necessary, the pulse pattern in accordance with environmental conditions such as temperature.

### EXAMPLES

In the following, the invention will be described only exemplarily on the basis of the drawing in which

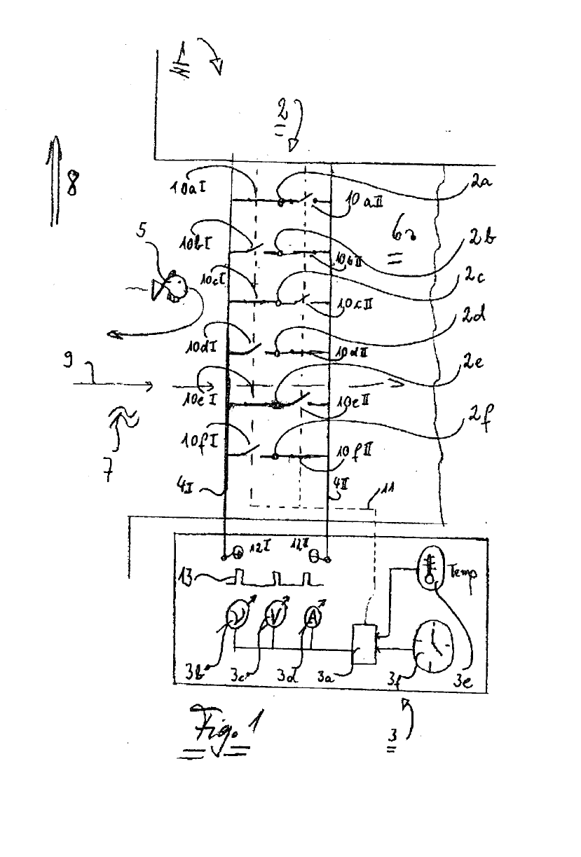

FIG. 1 shows a screen installation for shooing fish in accordance with a method of the present invention.

According to FIG. 1, a screen installation 1 according to the invention, which is generally marked as 1, comprises a screen 2 which is connected to a current and voltage pulse source 3 via lines 4I, 4II for selectively supplying, as required, screen bars 2a, 2b, 2c, 2d, 2f which can be isolated against each other. As will be described, a method for shooing fish 5 out of a specific region 6 can be realized by means of the screen installation 1, wherein the screen 2 is arranged in water, indicated at 7.

In the present case, the region 6 which should be kept free and from which the fish are to be shooed is the suction area for cooling water of a power plant. The screen installation 1 is perpendicularly directed away from a river, indicated by a flow direction 8, wherein water should be drawn along the arrows 9 through the screen installation in the region 6 without fish 5. The flowing water 8 is so clean that a large number of different species of fish 5 can live in this water 7.

In the present case, the screen is formed by electrically conducting bars 2a to 2f which are, e.g., spaced from each other by 5 to 10 cm. Each of the screen bars 2a to 2f can be connected to the line 4I via its relay 10aI for bar 2a, 10bI for bar 2b, 10cI for bar 2c, 10dI for bar 2d, 10eI or bar 2e and 10fI for bar 2f or can be connected to the line 4II via its relay 10aII, 10bII, 10cII, 10dII, 10eII and 10fII, respectively.

The relays 10aI to 10fII are connected to the current and voltage source via a control line 11 through which control pulses are output to the relays 10aI to 10fI in such a manner that from the two relays (10aI and 10aII) assigned to bar 2a at most one relay is closed, from the relays (10bI and 10bII) also at most one relay is closed, etc. For example, this is possible by changeover relays. However, the control line 11 or control lines 11 is/are adapted to switch each of the relay pairs (10aI, 10aII), (10bI, 10bII), etc. independently of the other pairs. For this purpose, the relays can have, e.g., a digitally encoded address, i.e. the relays can be activated via a bus.

It is pointed out that the number of individual bars in a real power plant will be significantly higher than drawn in the present case for reasons of a more simple illustration. If necessary, it is also possible in really existing plants or installations, not to be able to activate each screen bar individually but to define, e.g., groups of bars which have the same switching behavior of the relays from group to group. In such a case, it would be possible to assign a screen bar relay address several times. Moreover, a function feedback as to the correct closure state of relays to the power/voltage source and/or its controller 3a can be provided. The power/voltage source of the screen installation of the invention is connected to lines 4I, 4II via terminals 12I, 12II and can apply pulses to them, shown by a pulse train 13, said pulses being variable in view of the frequency v, the maximum voltage V and the maximum current A, as indicated by the frequency controller 3b, the voltage controller 3c and the current controller 3d. The variation is caused by the controller 3a, namely by regression to internally stored data, i.e. for example a consultation table in which desired groupings as well as current and voltage pulse strengths and pulse frequencies are stored for detected water temperatures, as indicated at 3e, as well as different times of day and seasons, indicated at 3f. Thus, at the same time also a switching of the relays 10aI to 10fII is caused via line 11 depending on temperature, season and time of day.

For example, the consultation table can be built up previously on the basis of tests.

The power source 3 is realized such that the potential differences between the bars 2a to 2f change quickly once the voltage source is excited, i.e. the rising edges of the pulses are steep, in the present case so steep that the maximum of the applied current or applied voltage (depending on whether a current or voltage limitation is effective) is reached within one millisecond. The fall can be slower. The rectangular pattern shown in FIG. 1 is only exemplary in this regard. It is pointed out that sufficiently steep edges and thus good shooing results can be achieved by means of leading edge phase switching.

The respective data for suitable shooing patterns can be determined by preliminary tests which are carried out, e.g., in a flow system with caught wild fish, thereby taking into account the fish species 5 living in the water 8, wherein the percentage of fish which have passed a screen can be evaluated. In the present case it is not shown that the screen installation according to the invention can be connected to further retaining barriers for shooing the fish, for example pressurized air curtains, flash light installations, additional screens arranged downstream, which might also be activated by the controller 3a. A passive pre-screen, i.e. a pre-screen which is free of current and voltage, which protects the swimmer against contact with the screen 2 to which a voltage and/or current pulse is applied in accordance with the invention is not shown either.

For shooing the fish, first the relays are closed in accordance with a pre-stored pattern, in the present case for example in an alternating manner, i.e. such that screens 2a, 2c, 2e are connected to a pole and the screens 2b, 2d and 2f lying therebetween are connected to a contrary pole. Then, the current and voltage source is activated such that, e.g., pulses having a pulse repetition frequency of 4 Hz at a voltage of 50 Volts and a steep rising edge are applied to the screen bars. Fish 5 transversely reaching the region 6 with the water 7 in the flow direction of the river 8 are shooed by these pulses back into the river 8, that is to say with high efficiency.

What is claimed is:

1. A method for moving fish out of a specific region, comprising providing at least one screen in the specific region in the water; and applying at least one of current or voltage pulses to said at least one screen.

2. The method for moving fish according to claim 1, wherein fish are moved out of a at least one of a water suction or inlet area of a technical installation.

3. The method for moving fish according to claim 1, wherein the fish used in waters comprise a plurality of different species.

4. The method for moving fish according to claim 1, wherein the waters comprise flowing waters.

5. The method for moving fish according to claim 1, wherein the screens further comprise screen bars wherein the screen bars alternately switch.

6. The method for moving fish according to claim 1, wherein the pulse repetition frequency is less than 20 Hz.

7. The method for moving fish according to claim 1, wherein the pulses have a steep rising edge wherein the pulse time period is less than 2.5 ms (milliseconds).

8. The method for moving fish according to claim 1, wherein the fish are shooed in the direction of one or more of free waters or in the direction of a bypass or a return path.

9. The method for moving fish according to claim 1, characterized in that the pulse repetition frequency and/or the pulse strength can be varied depending on the season and/or the time of day and/or the temperature.

10. The method for moving fish according to claim 1, wherein the at least one screen where the at least one of a current or power pulse is applied is used together with at least one retaining barrier.

11. The method for moving fish according to claim 1, further comprising a barrier comprising one or more of sound, pressurized air or light installations.

12. A screen for moving fish, comprising a plurality of metallically conducting screen bars wherein the bars are insulated from one another.

13. A screen installation for moving fish, comprising a screen according to claim 12 and at least one of a power or current pulse source for applying different current or voltage pulses to the insulated screen bars.

14. The screen installation according to claim 13, wherein the screen bars are elongated metal sheets.

15. The method for moving fish according to claim 2, wherein the technical installation is a power plant.

16. The method for moving fish according to claim 3, wherein the fish are selected from the group consisting of eels, salmon and trout.
